(19) United States
(12) Patent Application Publication
(10) Pub. No.: US 2022/0172413 A1
(43) Pub. Date: Jun. 2, 2022

(54) METHOD FOR GENERATING REALISTIC CONTENT

(71) Applicant: FOUNDATION FOR RESEARCH AND BUSINESS, SEOUL NATIONAL UNIVERSITY OF SCIENCE AND TECHNOLOGY, Seoul (KR)

(72) Inventors: Yu Jin LEE, Seoul (KR); Sang Joon KIM, Seoul (KR); Goo Man PARK, Seoul (KR)

(21) Appl. No.: 17/127,344

(22) Filed: Dec. 18, 2020

(30) Foreign Application Priority Data
Dec. 1, 2020 (KR) 10-2020-0165683

(51) Int. Cl. G06T 11/20; G06K 9/00; G06T 7/50; G06T 7/70; G06F 3/01; G06T 11/00; G06T 7/11

(52) U.S. Cl. CPC G06T 11/203; G06K 9/00711; G06K 9/00355; G06T 7/50; G06T 7/70; G06T 2207/20132; G06T 11/001; G06T 7/11; G06T 2200/24; G06T 2207/10016; G06F 3/011

(57) ABSTRACT

A method for generating realistic content based on a motion of a user includes generating a video of the user by means of a camera, recognizing a hand motion of the user from the generated video, deriving hand coordinates depending on the shape and position of a hand based on the recognized hand motion, outputting a picture on an output screen based on the derived hand coordinates, pre-processing the output picture based on a correction algorithm, and generating realistic content from the pre-processed picture based on a deep learning model.

### CROSS-REFERENCE TO RELATED APPLICATION

This application claims the benefit under 35 USC 119(a) of Korean Patent Application No. 10-2020-0165683 filed on 1 Dec. 2020, in the Korean Intellectual Property Office, the entire disclosures of which are incorporated herein by reference for all purposes.

### TECHNICAL FIELD

The present disclosure relates to a method for generating realistic content based on user motion recognition.

### BACKGROUND

Realistic content is digital content generated by using a technique of recognizing and analyzing behaviors, such as gestures, motions and voice, of a human being by means of various sensors and designed to enable a user to manipulate a virtual object like a real one.

A realistic content service is provided in various public places to offer realistic content through interaction with people. For example, the realistic content service offers realistic content to a user based on the position and motion of the user and thus can be used for user-customized advertising, realistic experiential advertising, Video On Demand (VOD) advertising, location-based advertising and the like.

As another example, the realistic content service may offer realistic content that enables the user to interact with a 3D object.

However, a conventional realistic content service is limited in that realistic content can be generated only by specific gestures and behaviors. That is, it is difficult to make realistic content flexible to respond to various interactions including circumstance and status information of a human being.

### SUMMARY

The technologies described and recited herein include a method for generating realistic content that is flexible to respond to various interactions with a human being as well as specific gestures and motions.

The problems to be solved by the present disclosure are not limited to the above-described problems. There may be other problems to be solved by the present disclosure.

An embodiment of the present disclosure provides a method for generating realistic content based on a motion of a user, including: generating a video of the user by means of a camera; recognizing a hand motion of the user from the generated video; deriving hand coordinates depending on the shape and position of a hand based on the recognized hand motion; outputting a picture on an output screen based on the derived hand coordinates; pre-processing the output picture based on a correction algorithm; and generating realistic content from the pre-processed picture based on a deep learning model.

According to another embodiment of the present disclosure, outputting of the picture on the output screen includes: outputting the picture in a picture layer on the output screen; and generating a user interface (UI) menu on the output screen based on the length of an arm from the recognized hand motion, and the UI menu allows line color and thickness of the picture to be changed.

According to yet another embodiment of the present disclosure, the pre-processing includes: producing equations of lines based on coordinates of the output picture; comparing the slopes of the produced equations; and changing the lines to a straight line based on the comparison result.

According to still another embodiment of the present disclosure, the pre-processing further includes: defining a variable located on the lines; generating a new line based on the defined variable; and correcting a curve based on the generated new line and a trajectory of the defined variable.

According to still another embodiment of the present disclosure, the pre-processing further includes: extracting the picture layer from the output screen; and cropping the pre-processed picture from the extracted picture layer based on the hand coordinates.

The above-described embodiment is provided by way of illustration only and should not be construed as liming the present disclosure. Besides the above-described embodiment, there may be additional embodiments described in the accompanying drawings and the detailed description.

According to any one of the above-described embodiments of the present disclosure, it is possible to provide a realistic content generating method capable of generating flexible realistic content including 3D content through various interactions with a human being.

Further, is possible to provide a realistic content generating method capable of improving a recognition rate of content based on a human being's motion by generating realistic content responding to the recognized motion of the human being through pre-processing using a correction algorithm.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 illustrates an overall flow of a method for generating realistic content, in accordance with various embodiments described herein.

FIG. 2 is a block diagram illustrating the configuration of a realistic content generating device, in accordance with various embodiments described herein.

FIG. 3A shows photos to explain a method for generating a UI menu on an output screen, in accordance with various embodiments described herein.

FIG. 3B shows photos to explain a method for generating a UI menu on an output screen, in accordance with various embodiments described herein.

FIG. 3C shows photos to explain a method for generating a UI menu on an output screen, in accordance with various embodiments described herein.

FIG. 3D shows photos to explain a method for generating a UI menu on an output screen, in accordance with various embodiments described herein.

FIG. 4 is an example depiction to explain a method for outputting a picture based on hand coordinates, in accordance with various embodiments described herein.

FIG. 5A is an example depiction to explain a method for pre-processing an output picture, in accordance with various embodiments described herein.

FIG. 5B is an example depiction to explain a method for pre-processing an output picture, in accordance with various embodiments described herein.

FIG. 5C is an example depiction to explain a method for pre-processing an output picture, in accordance with various embodiments described herein.

FIG. 5D is an example depiction to explain a method for pre-processing an output picture, in accordance with various embodiments described herein.

FIG. 6 is an example depiction to explain a method for generating realistic content based on a deep learning model, in accordance with various embodiments described herein.

### DETAILED DESCRIPTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the term “comprises or includes” and/or “comprising or including” used in the document means that one or more other components, steps, operation and/or the existence or addition of elements are not excluded from the described components, steps, operation and/or elements unless context dictates otherwise; and is not intended to preclude the possibility that one or more other features, numbers, steps, operations, components, parts, or combinations thereof may exist or may be added.

Throughout this document, the term “unit” includes a unit implemented by hardware and/or a unit implemented by software. As examples only, one unit may be implemented by two or more pieces of hardware or two or more units may be implemented by one piece of hardware.

In the present specification, some of operations or functions described as being performed by a device may be performed by a server connected to the device. Likewise, some of operations or functions described as being performed by a server may be performed by a device connected to the server.

Hereinafter, embodiments of the present disclosure will be explained in detail with reference to the accompanying drawings.

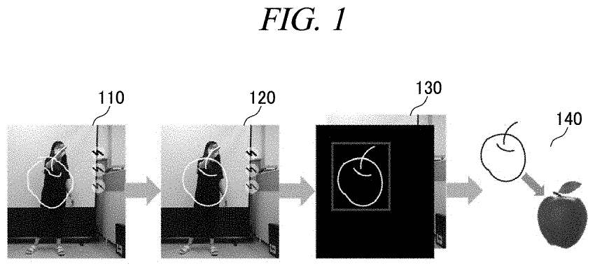

FIG. 1 illustrates an overall flow of a method for generating realistic content, in accordance with various embodiments described herein. Referring to FIG. 1, a realistic content generating device may generate flexible realistic content including 3D content through various interactions with a human being. For example, referring to FIG. 1A, the realistic content generating device may recognize a hand motion of a user from a video of the user acquired by a camera, and referring to FIG. 1B, the realistic content generating device may correct a picture output based on the recognized hand motion of the user. Then, referring to FIG. 1C, the realistic content generating device may extract a picture layer from an output screen and extract the corrected picture from the extracted picture layer, and referring to FIG. 1D, the realistic content generating device may generate a 3D object from the corrected picture by using a deep learning model.

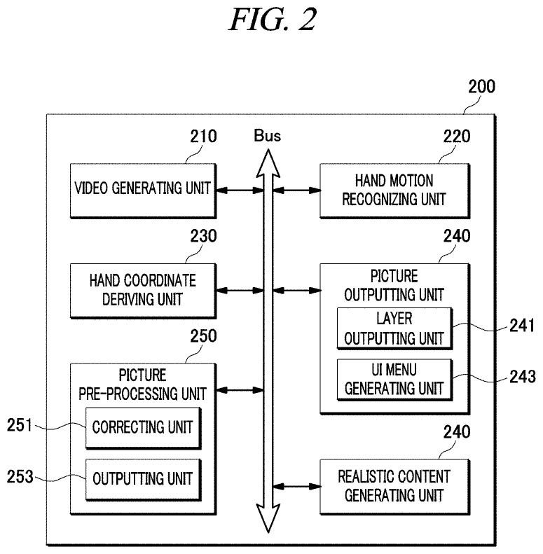

Hereinafter, the components of the realistic content generating device will be described in more detail. FIG. 2 is a block diagram illustrating the configuration of a realistic content generating device, in accordance with various embodiments described herein. Referring to FIG. 2, a realistic content generating device 200 may include a video generating unit 210, a hand motion recognizing unit 220, a hand coordinate deriving unit 230, a picture outputting unit 240, a picture pre-processing unit 250 and a realistic content generating unit 260. However, the above-described components 210 to 260 are illustrated just example of components that can be controlled by the realistic content generating device 200.

The components of the realistic content generating device 200 illustrated in FIG. 2 are typically connected to each other via a network. For example, as illustrated in FIG. 2, the video generating unit 210, the hand motion recognizing unit 220, the hand coordinate deriving unit 230, the picture outputting unit 240, the picture pre-processing unit 250 and the realistic content generating unit 260 may be connected to each other simultaneously or sequentially.

The network refers to a connection structure that enables information exchange between nodes such as devices and servers, and includes LAN (Local Area Network), WAN (Wide Area Network), Internet (WWW: World Wide Web), a wired or wireless data communication network, a telecommunication network, a wired or wireless television network and the like. Examples of the wireless data communication network may include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, VLC (Visible Light Communication), LiFi and the like, but may not be limited thereto.

The video generating unit 210 according to an embodiment of the present disclosure may generate a video of a user by means of a camera. For example, the video generating unit 210 may generate a video of poses and motions of the user by means of an RGB-D camera.

The hand motion recognizing unit 220 may recognize a hand motion of the user from the generated video. For example, the hand motion recognizing unit 220 may recognize a pose and a hand motion of the user from the generated video and support an interaction between the realistic content generating device 200 and the user. For example, the hand motion recognizing unit 220 may recognize the user's hand motion of drawing an “apple”. As another example, the hand motion recognizing unit 220 may recognize the user's hand motion of drawing a “bag”.

The hand coordinate deriving unit 230 may derive hand coordinates depending on the shape and position of a hand based on the recognized hand motion. For example, the hand coordinate deriving unit 230 may derive hand coordinates for “apple” that the user wants to express based on the hand motion of the user. As another example, the hand motion recognizing unit 220 may derive hand coordinates for “bag” that the user wants to express based on the hand motion of the user.

The picture outputting unit 240 according to an embodiment of the present disclosure may output a picture on an output screen based on the derived hand coordinates. For example, the picture outputting unit 240 may output a picture of “apple” on the output screen based on the hand coordinates for “apple”. As another example, the picture outputting unit 240 may output a picture of “bag” on the output screen based on the hand coordinates for “bag”.

The picture outputting unit 240 may include a layer outputting unit 241 and a UI menu generating unit 243. The layer outputting unit 241 may output a video layer and a picture layer on the output screen. For example, a video of the user generated by the camera may be output in the video layer and a picture based on hand coordinates may be output in the picture layer on the output screen.

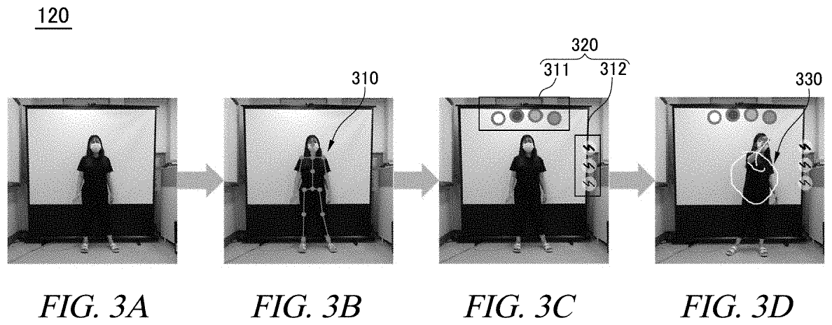

FIG. 3 shows photos to explain a method for generating a user interface (UI) menu on an output screen, in accordance with various embodiments described herein. Referring to FIG. 3, the picture outputting unit 240 may output a picture 330 based on the hand coordinates in the picture layer on the output screen. For example, the layer outputting unit 241 may output the picture 330 of “apple” in the picture layer based on the hand coordinates for “apple”.

Also, referring to FIG. 3, the picture outputting unit 240 may generate a UI menu 320 on the output screen. For example, the UI menu generating unit 243 may generate the UI menu 320 on the output screen based on the length of an arm from the recognized hand motion of the user. For example, the height of the UI menu 320 generated on the output screen may be set proportional to the length of the user's arm.

The UI menu 320 may support changes in line color and thickness of the picture. For example, the UI menu generating unit 243 may generate a UI menu 321 for changing a line color and a UI menu 322 for changing a line thickness on the output screen. For example, the user may move a hand to the UI menu 320 generated on the output screen and change the line color and thickness of the picture output in the picture layer.

Specifically, referring to FIG. 3A, the picture outputting unit 240 may receive a video of the user, and referring to FIG. 3B, the picture outputting unit 240 may acquire pose information 310 about the user from the received video. For example, the picture outputting unit 240 may use the user's skeleton information detected from the video as the pose information 310 about the user.

Referring to FIG. 3C, the picture outputting unit 240 may generate the UI menu 320 at a position corresponding to the length of the user's arm on the output screen based on the pose information 310. For example, the picture outputting unit 240 may generate the UI menu 321 for changing a line color at a position corresponding to the length of the user's right hand and the UI menu 322 for changing a line thickness at a position corresponding to the length of the user's left hand and on the output screen.

Referring to FIG. 3D, the picture outputting unit 240 may change the line color and thickness of the picture 330 output in the picture layer by means of the generated UI menu 320.

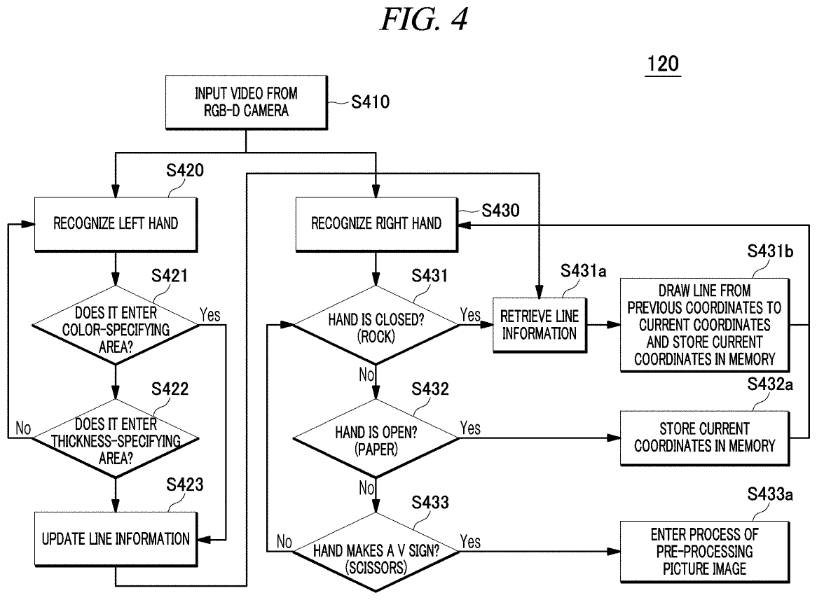

FIG. 4 is an example depiction to explain a method for outputting a picture based on hand coordinates, in accordance with various embodiments described herein. Referring to FIG. 4, the picture outputting unit 240 may detect and distinguish between left hand motions and right hand motions of the user and may update information of a picture to be output in the picture layer or complete drawing of a picture output in the picture layer based on a detected hand motion.

In a process S410, the picture outputting unit 240 may receive a video of the user from the camera. In a process S420, the picture outputting unit 240 may recognize the left hand of the user from the video. For example, the picture outputting unit 240 may adjust a line color or thickness of a picture to be output on the output screen based on the left hand motion of the user.

In a process S421, the picture outputting unit 240 may detect the user's hand motion from an area of the UI menu 321 for changing a line color. If the picture outputting unit 240 detects the user's hand motion from the area of the UI menu 321 for changing a line color, the picture outputting unit 240 may update information of the line color of the picture to be output in the picture layer in a process S423.

For example, if the picture outputting unit 240 detects that the user's left hand enters the area of the UI menu 321 for changing a line color and moves to an area of “red color”, the picture outputting unit 240 may change the line color of the picture to be output in the picture layer to “red color”.

In a process S422, the picture outputting unit 240 may detect the user's hand motion from an area of the UI menu 322 for changing a line thickness. If the picture outputting unit 240 detects the user's hand motion from the area of the UI menu 322 for changing a line thickness, the picture outputting unit 240 may update information of the line thickness of the picture to be output in the picture layer in the process S423.

For example, if the picture outputting unit 240 detects that the user's left hand enters the area of the UI menu 322 for changing a line thickness and moves to an area of “bold line”, the picture outputting unit 240 may change the line thickness of the picture to be output in the picture layer to “bold line”.

In a process S430, the picture outputting unit 240 may recognize the right hand of the user from the video. For example, the picture outputting unit 240 may determine whether or not to continue to output the picture on the output screen based on the status of the user's right hand.

In a process S431, the picture outputting unit 240 may detect that the user makes a closed fist with the right hand from the video. If the picture outputting unit 240 detects the user's closed right hand fist, the picture outputting unit 240 may retrieve the line information, which has been updated in the process S423, in a process S431a. Then, in a process S431b, the picture outputting unit 240 may generate an additional line from the previous coordinates to the current coordinates and then store the current coordinates based on the updated line information.

In a process S432, the picture outputting unit 240 may detect that the user opens the right hand from the video. If the picture outputting unit 240 detects the user's open right hand, the picture outputting unit 240 may store the current coordinates without generating an additional line in a process S432a.

In a process S433, the picture outputting unit 240 may detect that the user makes a “V” sign with the right hand from the video. If the picture outputting unit 240 detects a “V’ sign with the user's right hand, the picture outputting unit 240 may determine that the operation has been completed in the current state and perform a pre-processing to the picture output in the picture layer in a process S433a.

As described above, the picture outputting unit 240 may recognize the status of the user's hand as well as the user's hand motion and interact with the user.

The picture pre-processing unit 250 according to an embodiment of the present disclosure may pre-process the pre-processed picture based on a correction algorithm. The picture pre-processing unit 250 may include a correcting unit 251 and an outputting unit 253. The correcting unit 251 may correct a straight line and a curve of the picture output in the picture layer before inputting the user's picture based on the hand coordinates into a deep learning model and thus improve a recognition rate of the picture, and the outputting unit 253 may output the pre-processed picture.

The correcting unit 251 may produce an equations of lines based on coordinates of the picture output in the picture layer. The correcting unit 251 may compare slopes of the produced equations. Then, the correcting unit 251 may change the lines to a straight line based on the result of comparing the slope of the produced equation. For example, the correcting unit 251 may compare the slope of the produced equation with a predetermined threshold value. If the slopes of the produced equations have a small difference from the predetermined threshold value, the correcting unit 251 may change the lines to a straight line. For example, the correcting unit 251 may accurately correct an unnaturally crooked line, which is based on the hand coordinates, in the picture output in the picture layer to a straight line.

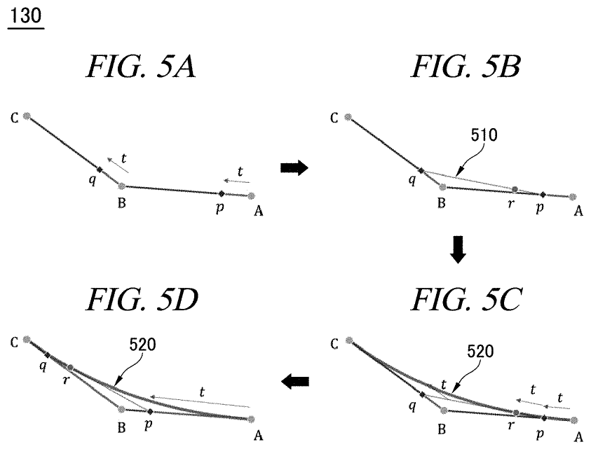

FIG. 5 is an example depiction to explain a method for pre-processing an output picture, in accordance with various embodiments described herein. Referring to FIG. 5, the correcting unit 251 may recognize a curve from the user's picture based on the hand coordinates and correct the curve.

The correcting unit 251 may produce an equation of each line based on the coordinates of the output picture. Referring to FIG. 5A, the correcting unit 251 may define a variable t located on a line ABC. For example, the correcting unit 251 may define the variable t on the existing line ABC output in the picture layer. Referring to FIG. 5B, the correcting unit 251 may generate a new line 510 based on the defined variable t. For example, the correcting unit 251 may generate the new line 510 by connecting points p and q located on the variable t defined on the existing line ABC. That is, the correcting unit 251 may define variables on the two lines, respectively, output in the picture layer to generate two variables and generate a new line by connecting the two generated variables.

Referring to FIG. 5C and FIG. 5D, the correcting unit 251 may generate a corrected curve 520 by correcting the existing curve based on the generated new line 510 and a trajectory r of the defined variable t. For example, the correcting unit 251 may also define a variable t on the generated new line 510 and generate the corrected curve 520 based on a trajectory r of the variable t defined on the generated new line 510. For example, the correcting unit 251 may correct a slightly crooked line in the picture output in the picture layer to a natural curve based on the hand coordinates.

The outputting unit 253 according to an embodiment of the present disclosure may output the picture layer from the output screen and crop the pre-processed picture from the extracted picture layer based on the hand coordinates. For example, the outputting unit 253 may extract the picture layer from the output screen and extract the picture based on the hand coordinates.

The picture pre-processing unit 250 may correct a straight line and a curve of the picture output in the picture layer by means of the correcting unit 251 before inputting the picture output in the picture layer into a deep learning model and extract the corrected picture by means of the outputting unit 253 and thus support the deep learning model to accurately recognize the picture that the user wants to express based on the hand motion.

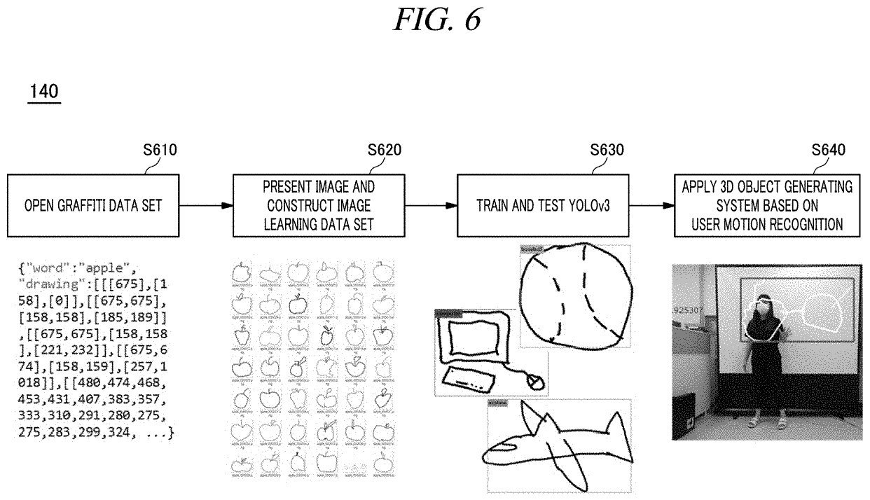

FIG. 6 is an example depiction to explain a method for generating realistic content based on a deep learning model, in accordance with various embodiments described herein. Referring to FIG. 6, the realistic content generating unit 260 may generate realistic content from the pre-processed picture based on the deep learning model. For example, the realistic content generating unit 260 may use YOLOv3 as a deep learning model for generating realistic content from the pre-processed picture. The deep learning model YOLOv3 is an object detection algorithm and performs a process including extracting a candidate area as the position of an object from the pre-processed picture and classifying a class of the extracted candidate area. The deep learning model YOLOv3 can perform the process including extracting a candidate area and classifying a class and thus can have a high processing speed. Therefore, the deep learning model YOLOv3 can generate realistic content in real time based on the recognized motion of the user.

In a process S610, the realistic content generating unit 260 may perform picture image learning of the deep learning model using an open graffiti data set. For example, the realistic content generating unit 260 may acquire a graffiti data set through the network and use the graffiti data set. The acquired graffiti data set is composed of coordinate data.

In a process S620, the realistic content generating unit 260 may present the graffiti data set composed of coordinate data in an image. For example, the realistic content generating unit 260 may present the graffiti data set composed of coordinate data in an image and construct a learning data set for image learning.

In a process S630, the realistic content generating unit 260 may use the constructed learning data set to train and test the deep learning model. For example, the realistic content generating unit 260 may train the deep learning model YOLOv3 with the constructed learning data set and test the training result.

In a process S640, the realistic content generating unit 260 may use the trained deep learning model to generate realistic content from the pre-processed picture. For example, the realistic content generating unit 260 may recognize the user's motion and input the pre-processed picture into the trained deep learning model YOLOv3 to generate realistic content. As another example, the realistic content generating unit 260 may output a previously generated 3D object in a virtual space based on the result of recognition of the input value by the deep learning model YOLOv3. For example, the realistic content generating unit 260 may recognize the user's motion and output a 3D object representing “glasses” in the virtual space.

That is, the realistic content generating device 200 may generate realistic content based on the user's motion and provide the generated realistic content to the user. For example, the realistic content generating device 200 may generate an object expressed by the user's hand motion into realistic content and provide the generated realistic content through the output screen. As another example, the realistic content generating device 200 may provide realistic content generated based on the user's hand motion to the user through the virtual space.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A method for generating realistic content based on a motion of a user, comprising:
generating a video of the user by a camera;
recognizing a hand motion of the user from the generated video;
deriving hand coordinates depending on a shape of a hand and position of the hand based on the recognized hand motion for drawing a picture of an object;
outputting the picture of the object on an output screen based on the derived hand coordinates after recognizing the hand motion indicating that the drawing is completed;
pre-processing the output picture of the object based on a correction algorithm;
generating realistic 3D content of the object from the pre-processed picture based on a deep learning model on the output screen; and
providing the generated realistic 3D content of the object to the user in a virtual space.

2. The method for generating realistic content of claim 1, wherein the outputting of the picture on the output screen includes:
outputting the picture in a picture layer on the output screen; and
generating a user interface (UI) menu on the output screen based on a length of an arm from the recognized hand motion, and
the UI menu allows line color and thickness of the picture to be changed.

3. The method for generating realistic content of claim 2, wherein the pre-processing includes:
producing equations of lines based on coordinates of the output picture;
comparing slopes of the produced equations; and
changing the lines to a straight line based on the comparison result.

4. The method for generating realistic content of claim 3, wherein the pre-processing further includes:
defining a variable located on the lines;
generating a new line based on the defined variable; and
correcting a curve based on the generated new line and a trajectory of the defined variable.

5. The method for generating realistic content of claim 4, wherein the pre-processing further includes:
extracting the picture layer from the output screen; and
cropping the pre-processed picture from the extracted picture layer based on the hand coordinates.

6. The method for generating realistic content of claim 1, wherein generating realistic 3D content of the object from the pre-processed picture based on the deep learning model comprises:
picture image learning by the deep learning model using an open graffiti data set,
wherein the open graffiti data set comprises coordinate data of an image, and
inputting the pre-processed picture into the deep learning model to generate the realistic 3D content of the object based on the coordinate data of the image from the open graffiti data set.

7. The method for generating realistic content of claim 6, wherein, a realistic content generating unit is used that comprises an object detection algorithm and performs a process including extracting a candidate area as a position of an object from the pre-processed picture and classifying a class of the extracted candidate area.
